(19) United States
(12) Patent Application Publication
(10) Pub. No.: US 2026/0187422 A1
(43) Pub. Date: Jul. 2, 2026

(54) PREFETCHING SUBNETWORKS OF GENERATIVE LARGE LANGUAGE MODELS

(71) Applicant: Samsung Electronics Co., Ltd., Suwon-si (KR)

(72) Inventors: Usman SAJID, San Jose, CA (US); Srivathsan SOUNDARARAJAN, Santa Clara, CA (US)

(21) Appl. No.: 19/334,798

(22) Filed: Sep. 19, 2025

Related U.S. Application Data
(60) Provisional application No. 63/841,324, filed on Jul. 9, 2025.
(60) Provisional application No. 63/703,898, filed on Oct. 4, 2024.
(60) Provisional application No. 63/703,897, filed on Oct. 4, 2024.
(60) Provisional application No. 63/703,896, filed on Oct. 4, 2024.

(51) Int. Cl. G06N 3/0475; G06N 3/09

(52) U.S. Cl. CPC G06N 3/0475; G06N 3/09

(57) ABSTRACT

Prefetching subnetworks of generative large language models is disclosed. A token to be processed by a generative large language model in order to generate an output based on the token may be identified. A machine learning model may identify a first subnetwork within a first layer of the generative large language model and a second subnetwork within a second layer of the generative large language model based on the token. The first subnetwork and the second subnetwork may be written to a memory. The generative large language model may be caused to generate the output based on the token using the first subnetwork and the second subnetwork in the memory.

### RELATED APPLICATION DATA

This application claims the benefit of U.S. Provisional Patent Application Serial Nos. 63/703,896, filed October 4, 2024; 63/703,897, filed October 4, 2024; 63/703,898, filed October 4, 2024; and 63/841,324, filed July 9, 2025, which are incorporated by reference herein for all purposes.

### FIELD

The disclosure relates generally to generative large language models, and more particularly to prefetching subnetworks of generative large language models.

### BACKGROUND

Compute resources and memory resources are utilized differently for different applications. Some applications such as machine learning applications include first operations that consume substantial compute resources and second operations that consume substantial memory resources. Performance of the first and second operations within these applications may be limited based on compute resources, memory resources, or both.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 illustrates a system including a generative large language model, according to embodiments of the disclosure.

FIG. 2 illustrates a representation of a generative large language model, according to embodiments of the disclosure.

FIG. 3A illustrates an example of identifying subnetworks within layers of a generative large language model based on a token, according to embodiments of the disclosure.

FIG. 3B illustrates an example of identifying subnetworks within layers of a generative large language model based on an additional token, according to embodiments of the disclosure.

FIG. 4 illustrates a representation of a machine learning model and a generative large language model, according to embodiments of the disclosure.

FIG. 5 illustrates a representation of an output generated by a machine learning model based on a token to be processed by a generative large language model, according to embodiments of the disclosure.

FIG. 6A illustrates a representation a logical portion of prefetching subnetworks of a generative large language model, according to embodiments of the disclosure.

FIG. 6B illustrates a representation of a physical portion of prefetching subnetworks of a generative large language model, according to embodiments of the disclosure.

FIG. 7 shows a flowchart of an example procedure for writing a first subnetwork and a second subnetwork to a memory, according to embodiments of the disclosure.

FIG. 8 shows a flowchart of an example procedure for causing a generative large language model to generate an output using subnetworks in a second memory, according to embodiments of the disclosure.

FIG. 9 shows a flowchart of an example procedure for causing a generative large language model to generate an output using first subnetworks and second subnetworks in a memory, according to embodiments of the disclosure.

### SUMMARY

A token to be processed by a generative large language model in order to generate an output based on the token may be identified. A machine learning model may identify a first subnetwork within a first layer of the generative large language model and a second subnetwork within a second layer of the generative large language model based on the token. The first subnetwork and the second subnetwork may be written to a memory. The generative large language model may be caused to generate the output based on the token using the first subnetwork and the second subnetwork in the memory.

A token to be processed by a generative large language model in order to generate an output may be identified. A machine learning model may identify one or more subnetworks within the generative large language model based on the token. The one or more subnetworks may be prefetched from a first memory into a second memory. The generative large language model may be caused to generate the output using the one or more subnetworks in the second memory.

A token to be processed by a generative large language model in order to generate an output may be identified. A machine learning model may first subnetworks and second subnetworks within the generative large language model based on the token. The first subnetworks may correspond to a first iteration of the generative large language model for the token. The second subnetworks may correspond to a second iteration of the generative large language model for an additional token following the token. The first subnetworks may be written to a memory. The generative large language model may be caused to generate the output using the first subnetworks in the memory.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Generative large language models are trained on training data (e.g., corpuses of training data) to generate outputs based on user inputs or “prompts.” Once trained, a generative large language model is capable of generating outputs within different subject matter domains. For example, the generative large language model may generate an output in a first subject matter domain (e.g., a natural language output explaining a historical event) based on a first user input. In another example, the generative large language model may generate an output in a second subject matter domain (e.g., lines of executable code) based on a second user input.

In order to generate outputs within different subject matter domains, layers within the generative large language model may include subnetworks or “experts” having weights learned during training that correspond to one or more particular subject matter domains. For instance, the generative large language model may select a first subnetwork or “expert” from a particular layer within the model in order to generate the output in the first subject matter domain. The generative large language model may select a second subnetwork or “expert” from the particular layer in order to generate the output in the second subject matter domain.

It is to be appreciated that generating outputs using the generative large language model can consume a substantial amount of compute and memory resources. In some embodiments, the generative large language model may be supported by a set of resources including a processor, a first memory, and a second memory. In these embodiments, the processor executes instructions that cause the processor to perform operations using data included in the first memory and/or the second memory. The first memory may be a “slow” memory such as storage (e.g., a remote memory) and the first memory includes data describing all of the subnetworks or “experts” in each of the layers within the generative large language model. The second memory may be a “fast” memory such as a cache (e.g., a local memory) and the second memory stores data that the processor can access in a relatively short amount of time.

Consider the example above in which the generative large language model selects the first subnetwork from the particular layer in order to generate the output in the first subject matter domain. In this example, the processor checks the second memory for data describing the first subnetwork from the particular layer. If the first subnetwork is included in the second memory, then the processor reads the first subnetwork from the second memory and uses the first subnetwork to generate the output in the first subject matter domain. If the first subnetwork is not included in the second memory, then the processor reads the first subnetwork from the first memory in order to generate the output in the first subject matter domain. In some embodiments, reading the first subnetwork from the first memory adds latency to generating the output in the first subject matter domain compared to reading the first subnetwork from the second memory because the first memory is the “slow” memory.

In order to avoid adding latency to generation tasks, a machine learning model is trained to predict subnetworks within layers selected by the generative large language model in order to process a token (e.g., a discrete representation of information processable by the generative large language model). In some embodiments, the machine learning model is included in the generative large language model. In other embodiments, the machine learning model may be separate from (e.g., independent of) the generative large language model.

In some embodiments, the machine learning model identifies/receives a token to be processed by the generative large language model in order to generate the output in the first subject matter domain. Based on the token, the machine learning model identifies that the first subnetwork within the particular layer will be selected by the generative large language model to process the token. If the first subnetwork is not available in the second memory, then the first subnetwork can be prefetched from the first memory into the second memory.

By prefetching the first subnetwork within the particular layer from the first memory into the second memory, the first subnetwork may be available in the second memory when requested by the processor. Since data describing the first subnetwork is available in the second memory (e.g., the “fast” memory), the data describing the first subnetwork does not need to be retrieved from the first memory (e.g., the “slow” memory) at processing time in order to generate the output in the first subject matter domain. As a result, additional latency associated with reading the first subnetwork from the first memory may be avoided.

In some embodiments, the machine learning model may be trained to predict the subnetworks selected to process the token as well as additional subnetworks selected to process an additional token following the token. In these embodiments, the machine learning model generates a confidence score for the additional subnetworks selected to process the additional token. If the confidence score is greater than a threshold value, then the additional subnetworks may be prefetched from the first memory into the second memory. It is to be appreciated that, in some embodiments, having the additional subnetworks available in the second memory may also avoid latency in generating outputs using the generative large language model.

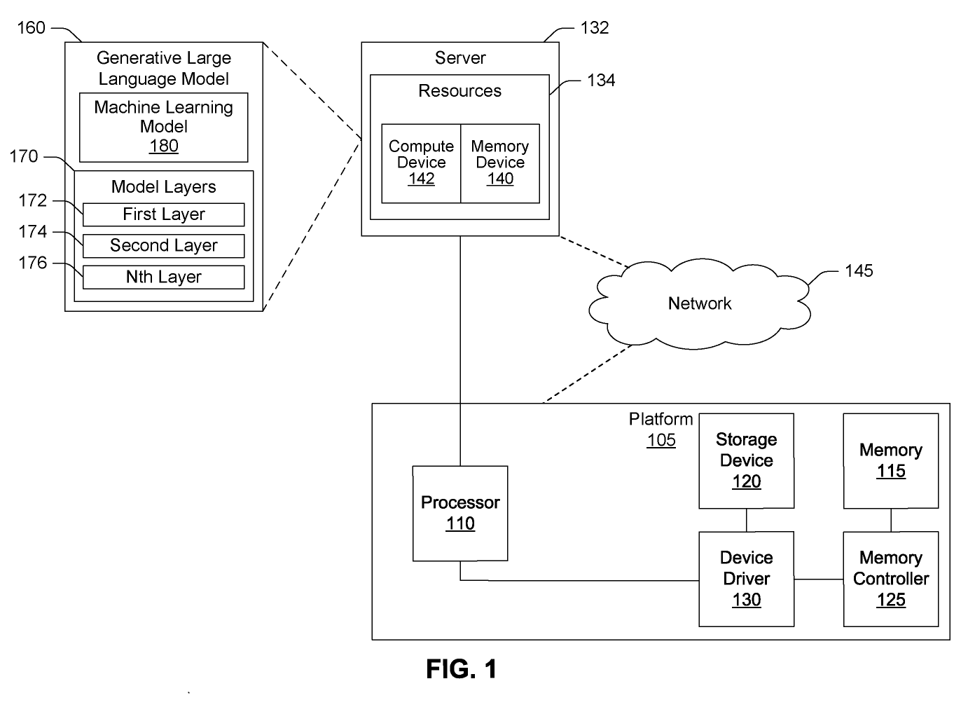

FIG. 1 illustrates a system including a generative large language model 160, according to embodiments of the disclosure. As shown in FIG. 1, a platform 105 (e.g., a host) includes a processor 110, a memory 115, and a storage device 120. The processor 110 is representative of a variety of types of processors such as central processing units (CPUs), accelerators, graphics processing units (GPUs), processors implemented using field-programmable gate arrays (FPGAs) (e.g., soft processors), etc. The memory 115 can include volatile memory and/or non-volatile memory and the memory 115 is representative of a variety of types of memory such as random access memory (RAM), static RAM (SRAM), dynamic RAM (DRAM), synchronous DRAM (SDRAM), etc.

Read/write operations performed relative to the memory 115 may be managed by a memory controller 125. In the illustrated example, the processor 110 is communicatively coupled to the memory controller 125 via a wired or wireless connection. The processor 110 is also shown to be communicatively coupled to the storage device 120 via a device driver 130. The device driver 130 can control the storage device 120 and the device driver 130 may be implemented using software, hardware, or a combination of software and hardware.

The system shown in FIG. 1 is illustrated to include a server 132 having resources 134 which may include one or more memory devices 140 and one or more compute devices 142. Although the server 132 is illustrated as a single server, it is to be appreciated that, in some embodiments, the resources 134 may be distributed across multiple servers 132. The compute devices 142 may include one or more processors such as CPUs, application specific integrated circuits (ASICs), accelerators, GPUs, neural processing units (NPUs), tensor processing units (TPUs), etc. A memory device 140 can include volatile memory and/or non-volatile memory. In some embodiments, the memory device 140 may include a variety of types of memory such as DRAM, SRAM, magnetoresistive RAM (MRAM), phase change memory (PCM), Flash, read-only memory (ROM), and/or combinations of such.

In some embodiments, the resources 134 may be communicatively coupled to the platform 105 via a wired or wireless connection. By way of example, the processor 110 may be connected to the server 132 via a network 145. In the illustrated example, the resources 134 are at least partially dedicated to a generative large language model 160. As shown, the generative large language model 160 includes model layers 170 (e.g., hundreds of layers). In FIG. 1, the model layers 170 are illustrated to include a first layer 172, a second layer 174, and an Nth layer 176.

In some embodiments, the generative large language model 160 is trained on training data (e.g., corpuses of training data) to generate outputs based on user inputs or “prompts.” Typically, the generative large language model 160 is trained by one or more operators or users that prepare the training data and monitor the training. Once trained, the generative large language model 160 is capable of generating outputs within different subject matter domains.

In order to generate outputs within different subject matter domains, the model layers 170 can include multiple subnetworks or “experts” having weights learned during training that correspond to one or more particular subject matter domains. For instance, the first layer 172 may include a first subnetwork that is selected to process the first user input in order to generate the natural language output explaining the historical event. Similarly, the first layer 172 can include a second subnetwork that is selected to process the second user input in order to generate the output including the lines of executable code.

In the example shown in FIG. 1, the generative large language model 160 may be trained such that “processing” by the generative large language model 160 refers to an inference process rather than a training process. Consider an example in which the resources 134 implement the generative large language model 160 to process the second user input after previously implementing the generative large language model 160 to process the first user input. In this example, a processor included in the resources 134 executes instructions which cause the processor to request the second subnetwork included in the first layer 172 from a first memory in order to process the second user input. For instance, the first memory may be a “fast” memory such as a cache or a local memory. If the second subnetwork is included in the first memory, then the processor receives the second subnetwork and processes the second user input using the second subnetwork.

However, if the second subnetwork is not included in the first memory, then the processor requests the second subnetwork from a second memory. Compared to the first memory, the second memory may be a “slow” memory such as storage or a remote memory. As a result, receiving the second subnetwork from the second memory increases latency in processing the second user input relative to receiving the second subnetwork from the first memory.

A machine learning model 180 is illustrated to be included in the generative large language model 160 in the example depicted in FIG. 1. In some embodiments, the machine learning model 180 may be separate (e.g., independent) from the generative large language model 160. The machine learning model 180 is trained (e.g., during training of the generative large language model 160) to predict subnetworks or “experts” selected by the generative large language model 160 to process different portions of user inputs or “prompts.”

In some embodiments, the machine learning model 180 is trained to predict subnetworks or “experts” selected by the generative large language model 160 for processing particular tokens. As described below, tokens are discrete representations of information processable by the generative large language model 160. By way of example, the generative large language model 160 may represent the first user input as one or more tokens which the generative large language model 160 may process to identify the historical event to explain. The generative large language model 160 may then begin to generate one or more tokens that correspond to portions of the explanation of the historical event.

In some embodiments, the machine learning model 180 is trained to receive an input including a token (or an identification of the token) and generate a corresponding output that indicates subnetworks or “experts” within the model layers 170 to be selected by the generative large language model 160 in order to process the token. Consider an example in which the processor included in the resources 134 executes instructions which cause the processor to request the first subnetwork included in the first layer 172 from the first memory (e.g., the “fast” memory) in order to process a particular token. In this example, the machine learning model 180 receives the particular token (or an identification of the particular token) as an input and the machine learning model 180 generates an output indicating that the first subnetwork included in the first layer 172 will be requested by the generative large language model 160 in order to process the particular token.

When the output is generated by the machine learning model 180 indicating that the first subnetwork will be requested by the generative large language model 160, the first subnetwork may be prefetched, for example, from the second memory (e.g., the “slow” memory) and into the first memory. Additionally or alternatively, the first subnetwork may be identified as included in the first memory (e.g., based on a recent use of the first subnetwork by the generative large language model 160). In some embodiments, the first subnetwork included in the first layer 172 is available in the first memory when the processor requests the first subnetwork from the first memory. This may avoid latency which would be added by requesting the first subnetwork from the second memory (e.g., the “slow” memory).

It is to be appreciated that, in some embodiments, the machine learning model 180 is not limited to generating subnetworks or “experts” to be selected by the generative large language model 160 to process the particular token in a current iteration of processing tokens using the model layers 170. Rather, in some embodiments, the machine learning model 180 is also trained to predict subnetworks or “experts” selected by the generative large language model 160 to process an additional token following the particular token in a next iteration of processing tokens using the model layers 170. For instance, the machine learning model 180 may receive the input including the particular token and the machine learning model 180 may generate a corresponding output indicating that a third subnetwork included in the first layer 172 will be requested by the generative large language model 160 in order to process the additional token following the particular token.

After generating this output, the third subnetwork can be prefetched from the second memory into the first memory. As used herein, “prefetching” refers to one or more processes of loading data and/or intermediate results before subsequent processing. By prefetching the third subnetwork from the second memory, the third subnetwork may be available in the first memory when the processor requests the third subnetwork in order to process the additional token. Notably, utilizing the machine learning model 180 to predict subnetworks or “experts” to be selected by the generative large language model 160 may be beneficial when the generative large language model 160 is implemented using various different sets of resources included in the resources 134.

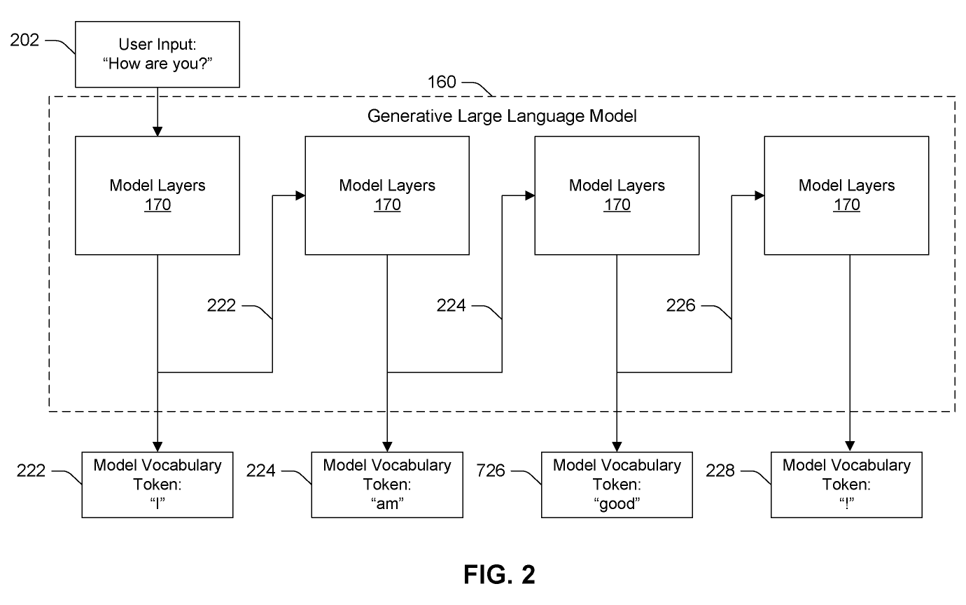

FIG. 2 illustrates a representation of a generative large language model 160, according to embodiments of the disclosure. In some embodiments, the generative large language model 160 includes a transformer-based model; however, the generative large language model 160 is not limited to any particular model architecture. In the example depicted in FIG. 2, the generative large language model 160 receives a user input 202. The user input 202 is a natural language question stating “how are you?” As shown, the user input 202 is processed by the model layers 170 to generate a representation of the user input 202. Generally, the representation of the user input 202 is an indication of the user input 202 in a format processable by the generative large language model 160. In some embodiments, the representation of the user input 202 may include a token-based representation.

For instance, a token is a discrete portion of a machine learning model input/output that typically maps between a word/character and an embedding vector in a latent space of the machine learning model. A vocabulary of the machine learning model refers to the set of all tokens and corresponding embedding vectors that the model has learned during training. In some embodiments, the user input 202 is represented as a sequence of tokens and this sequence of tokens is processed by the generative large language model 160 in a first iteration using the model layers 170 to predict a next token in the sequence which represented as a first token 222 in FIG. 2.

As shown, the first token 222 is “I” within the model vocabulary. First context (e.g., generated along with the first token 222 in the first iteration) may include data describing a variety of different information related to processing the user input 202 such as how the first token 222 is semantically related to an output to be generated by the generative large language model 160, previous user inputs to the generative large language model 160, outputs generated by the generative large language model 160 based on the previous user inputs, etc.

The first token 222 and the first context are processed by the model layers 170 in a second iteration to generate a second token 224 within the model vocabulary and second context. In the illustrated example, the second token 224 is “am.” In a third iteration, the second token 224 and the second context are processed by the model layers 170 to generate a third token 226 and third context. The third token 226 is “good” which is processed along with the third context in a fourth iteration. In this fourth iteration, the model layers 170 process the third token 226 and the third context to generate a fourth token 228. As shown, the fourth token 228 is “!” which is an end token that may be indicated by fourth context generated during the fourth iteration.

Accordingly, the complete output from the generative large language model 160 is a natural language statement of “I am good!” which is responsive to the user input 202 asking “how are you? It should be appreciated that, in some embodiments, the generative large language model 160 may be capable of generating outputs in a variety of different subject matter domains. For example, the generative large language model 160 may generate outputs that include solutions to solvable problems or templates for electronic communications.

In some embodiments, the generative large language model 160 generates outputs in the different subject matter domains using subnetworks or “experts” within the model layers 170 that have learned weights corresponding to the different subject matter domains. In these embodiments, during any particular iteration, the generative large language model 160 only selects a portion of the subnetworks or “experts” within the model layers 170 to predict a next token. As described below, if the selected subnetworks or “experts” within the model layers 170 are not available in a cache or a local memory during the particular iteration, then the subnetworks or “experts” are fetched from storage or a remote memory which adds latency to the particular iteration.

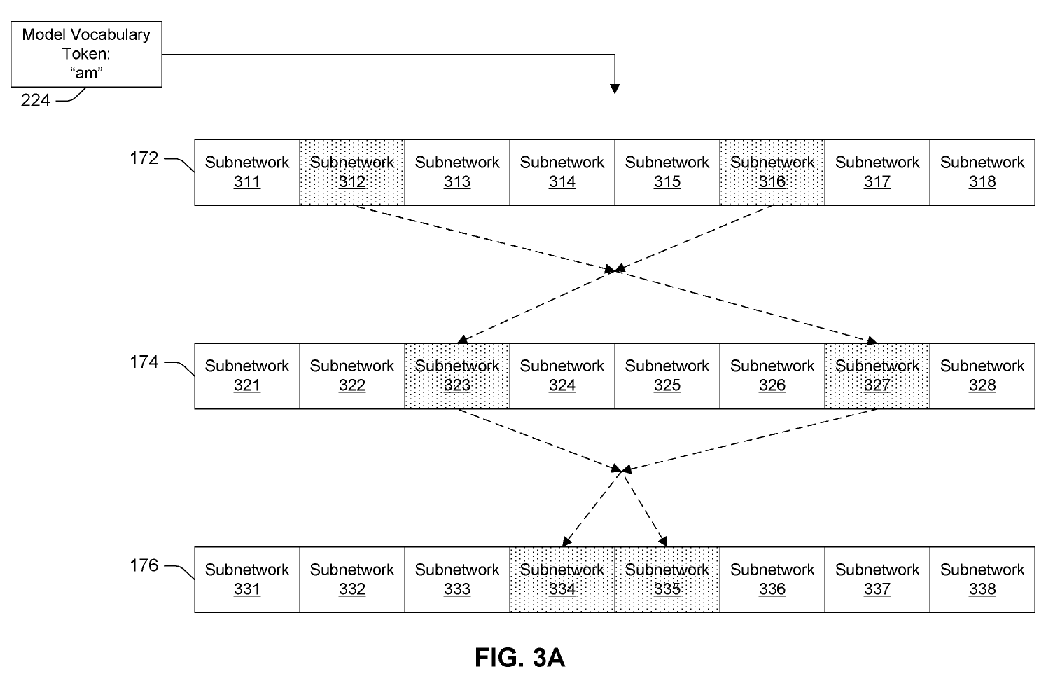

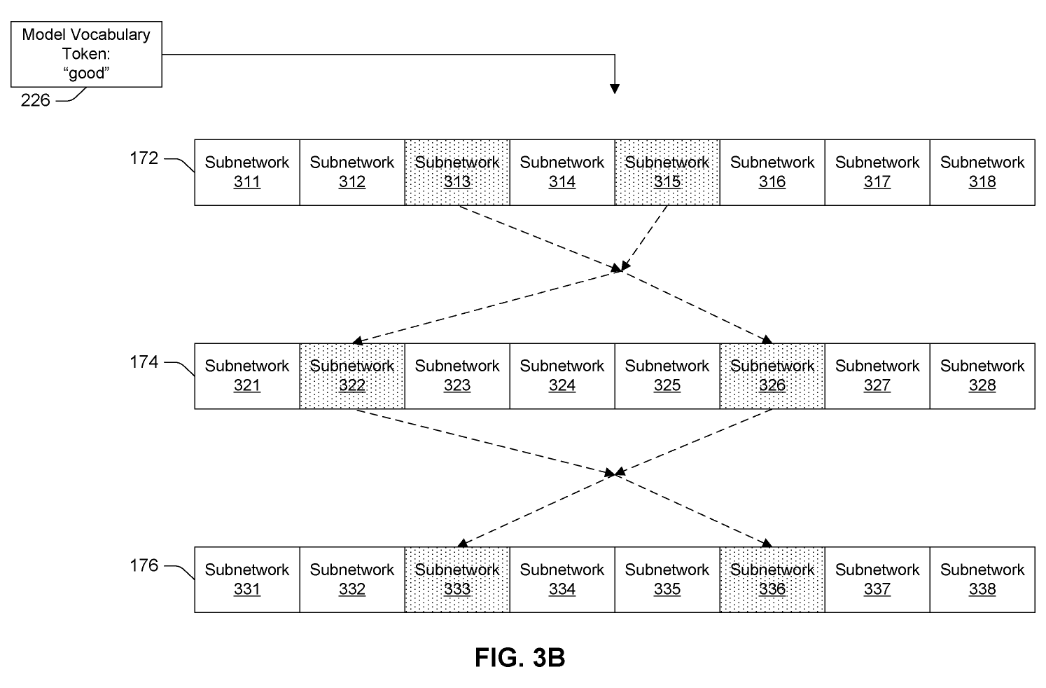

FIG. 3A illustrates an example of identifying subnetworks within layers of a generative large language model 160 based on a token, according to embodiments of the disclosure. As shown in FIG. 3A, the example token is the second token 224 which is also illustrated in FIG. 2. As further shown, FIG. 3A includes the first layer 172, the second layer 174, and the Nth layer 176 of the model layers 170.

In some embodiments, subnetworks or “experts” included in the model layers 170 that are selected to process a particular token in a first instance may also be selected (e.g., have a high probability of being selected) to process the particular token in a second instance. For example, a particular layer of the model layers 170 includes eight subnetworks or “experts” and the same two subnetworks are selected to process the particular token in both the first and second instances. It is to be appreciated that, in some embodiments, it is possible to accurately predict the subnetworks or “experts” selected by the generative large language model 160 in each layer of the model layers 170 (e.g., based on the particular token) as described below.

With reference to FIG. 3A, the second token 224 is to be processed by the first layer 172, the second layer 174, and the Nth layer 176 of the generative large language model 160. As shown in FIG. 3A, the first layer 172 includes subnetworks 311-318, the second layer 174 includes subnetworks 321-328, and the Nth layer 176 includes subnetworks 331-338. In the illustrated example, subnetworks 312, 316 are selected from the first layer 172 to process the second token 224.

It is to be appreciated that a processes/mechanism used to select the subnetworks 312, 316 from the first layer 172 may be known or unknown. For instance, the subnetworks 312, 316 may be selected using a gating function or a “router network” that computes probability scores for each of the subnetworks 311-318 and selects the subnetworks 312, 316 as having the highest probability scores. As described below, probability scores computed by the generative large language model 160 for selecting subnetworks or “experts” may be leveraged to compute confidence scores for prefetching the subnetworks or “experts.” In some embodiments, the subnetwork 312 includes first weights learned during training and the subnetwork 316 includes second weights learned during training that are independent of the first weights. For instance, the subnetwork 312 may include a first multilayer perceptron and the subnetwork 316 may include a second multilayer perceptron.

As shown, subnetworks 323, 327 are selected from the second layer 174 to process the second token 224 and subnetworks 334, 335 are selected from the Nth layer 176 to process the second token 224. The subnetworks 323, 327, 334, 335 may be selected as described above relative to the subnetworks 312, 316. Accordingly, a portion of the generative large language model 160 that includes the subnetworks 312, 316, 323, 327, 334, 335 is selected to process the second token 224.

It is to be appreciated that, in some embodiments, the generative large language model 160 may select the subnetworks 312, 316, 323, 327, 334, 335 “locally” using a gating function or a “router network” for each of the first layer 172, the second layer 174, and the Nth layer 176. It is also to be appreciated that, in some embodiments, the subnetworks 312, 316, 323, 327, 334, 335 may be predicted “globally” for the model layers 170 based on the second token 224. In general, subnetworks selected “locally” may be selected at each layer of the model layers 170 such as by selecting the subnetworks 312, 316 from the first layer 172 in a first local selection; selecting the subnetworks 323, 327 from the second layer 174 in a second local selection; and selecting the subnetworks 334, 335 from the Nth layer 176 in a third local selection. Subnetworks selected “globally” may generally be selected once for all layers of the model layers 170 such as by selecting the subnetworks 312, 316, 323, 327, 334, 335 in a global selection. As described below, since the subnetworks 312, 316, 323, 327, 334, 335 can be predicted “globally” for all layers of the model layers 170, the subnetworks 312, 316, 323, 327, 334, 335 may be prefetched to reduce latency in processing the second token 224.

FIG. 3B illustrates an example of identifying subnetworks within layers of a generative large language model 160 based on an additional token, according to embodiments of the disclosure. As shown in FIG. 3B, the additional token is the third token 226 which is the token following the second token 224 in FIG. 2. In some embodiments, no other tokens are generated by the generative large language model 160 between the second token 224 and the third token 226. In order to process the third token 226, subnetworks 313, 315 are selected from the first layer 172; subnetworks 322, 326 are selected from the second layer 174; and subnetworks 333, 336 are selected from the Nth layer 176. Accordingly, a portion of the generative large language model 160 that includes the subnetworks 313, 315, 322, 326, 333, 336 is selected to process the third token 226.

Similar to the example in FIG. 3A, the generative large language model 160 may select the subnetworks 313, 315, 322, 326, 333, 336 “locally” (e.g., per layer of the model layers 170). In some embodiments, the subnetworks 313, 315, 322, 326, 333, 336 may be predicted “globally” for the model layers 170 based on the second token 224. It is to be appreciated that, in some embodiments, the subnetworks 313, 315, 322, 326, 333, 336 selected by the generative large language model 160 to process the third token 226 may be predicted based on the second token 224 (e.g., without using or generating the third token 226). As described below, since the subnetworks 313, 315, 322, 326, 333, 336 can be predicted “globally” for the model layers 170 based on the second token 224, the subnetworks 313, 315, 322, 326, 333, 336 may be prefetched to reduce latency in processing the third token 226.

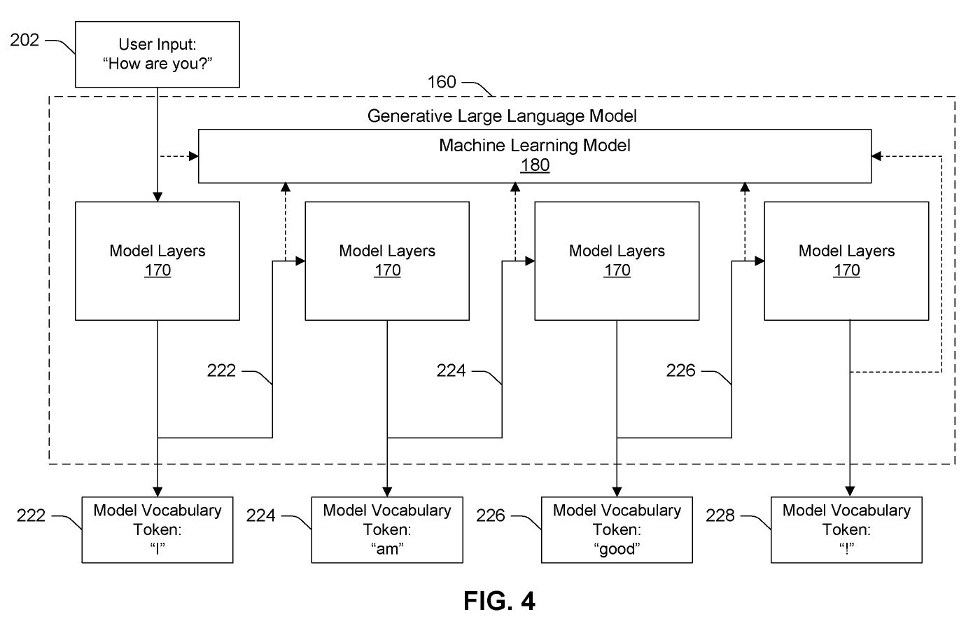

FIG. 4 illustrates a representation of a machine learning model 180 and a generative large language model 160, according to embodiments of the disclosure. In the representation, the machine learning model 180 is illustrated to be included in the generative large language model 160; however, in some embodiments, the machine learning model 180 may be separate from the generative large language model 160. In some embodiments, the machine learning model 180 includes a multilayer perceptron; however, the machine learning model 180 is not limited to any particular model architecture. Accordingly, in some embodiments, the machine learning model 180 may include a three-layer multilayer perceptron. In other embodiments, the machine learning model 180 can include other architectures (e.g., probabilistic, tree-based, cluster-based, etc.) which may leverage various types of machine learning (e.g., semi-supervised, supervised, unsupervised, reinforcement, transfer, etc.).

In FIG. 4, the machine learning model 180 is illustrated as receiving inputs to and outputs from the model layers 170 of the generative large language model 160. In some embodiments, the machine learning model 180 may receive the outputs from the model layers 170 as including information/data describing subnetworks or “experts” selected from each layer of the model layers 170 by the generative large language model 160 to process the inputs to the model layers 170. It is to be appreciated that, in some embodiments, the inputs to the model layers 170 and the outputs from the model layers 170 may be used as training data to train the machine learning model 180 to predict subnetworks or “experts” that the generative large language model 160 will select from each layer of the model layers 170 in order to process a token.

As described above, subnetworks or “experts” included in the model layers 170 that are selected to process a particular token in a first instance may have a high probability of being selected to process the particular token in a second instance. For instance, as the generative large language model 160 is trained, subnetworks or “experts” included in layers of the model layers 170 learn to process particular types of tokens (e.g., to prevent expert collapse) and router networks included in the layers of the model layers 170 learn to select the subnetworks or “experts” to process the particular types of tokens. In some embodiments, the machine learning model 180 is trained (e.g., using the inputs to and the outputs from the model layers 170) to identify subnetworks within each layer of the model layers 170 selected by the generative large language model 160 based on a token to be processed by the model layers 170. In these embodiments, the machine learning model 180 may be trained to identify subnetworks within each layer of the model layers 170 selected by the generative large language model 160 in a first iteration to process the token and also in a second iteration to process an additional token following the token. In some embodiments, the machine learning model 180 may be trained to identify subnetworks within each layer of the model layers 170 selected by the generative large language model 160 in the first iteration and the second iteration and also generate a confidence score for the identified subnetworks in the second iteration. As described below, the confidence score indicates a relative amount of certainty that the identified subnetworks in the second iteration (e.g., output from the machine learning model 180) will be selected by the generative large language model 160 in the second iteration to process the additional token. In some embodiments, the confidence score may be utilized for determining whether to prefetch the identified subnetworks in the second iteration (e.g., from a “slow” memory into a “fast” memory).

As described above, in some embodiments, the machine learning model 180 is trained during training of the generative large language model 160. In some embodiments, the machine learning model 180 is included in the generative large language model 160 and both the machine learning model 180 and the generative large language model 160 are trained in an end-to-end manner/configuration. For instance, the machine learning model 180 may be trained along with the generative large language model 160 in a manner similar to training the generative large language model 160 (e.g., without the machine learning model 180).

In some embodiments, the machine learning model 180 learns from (e.g., is trained on) the inputs to the model layers 170 and the outputs from the model layers 170, for example, to predict subnetworks or “experts” selected from each layer of the model layers 170 to process a token. For instance, the inputs to the model layers 170 include the token and the outputs from the model layers 170 include subnetworks or “experts” selected from each layer of the model layers 170 to process the token. Accordingly, the machine learning model 180 is trained to identify subnetworks selected from each layer of the model layers 170 to process a particular token based on the particular token. It is to be appreciated that, in some embodiments, the machine learning model 180 may be trained to identify/predict subnetworks selected from each layer of the model layers 170 “globally” (e.g., one selection for all layers) regardless of whether the generative large language model 160 selects subnetworks from each layer of the model layers 170 “locally” (e.g., one selection for each layer).

Although the machine learning model 180 is described as being trained as part of training the generative large language model 160, it is to be appreciated that, in some embodiments, the machine learning model 180 may be trained differently than or separately from the generative large language model 160. In some embodiments, the generative large language model 160 may be trained end-to-end before training the machine learning model 180. In these embodiments, the machine learning model 180 may be trained to predict subnetworks selected from each layer of the model layers 170 by the generative large language model 160 using at least some transfer learning in which weights learned by training the generative large language model 160 may be transferred to the machine learning model 180.

In some embodiments, the inputs to and the outputs from the model layers 170 of the generative large language model 160 may be utilized to generate training data for training the machine learning model 180. It is to be appreciated that the inputs to the model layers 170 and the outputs from the model layers 170 may be leveraged to generate training data including pairs of tokens and corresponding subnetworks selected from the model layers 170 to process the tokens. Once the training data is generated, the machine learning model 180 may be trained on the training data (e.g., using one or more loss functions) to generate outputs including identified subnetworks in each layer of the model layers 170 based on inputs including tokens to be processed by the model layers 170.

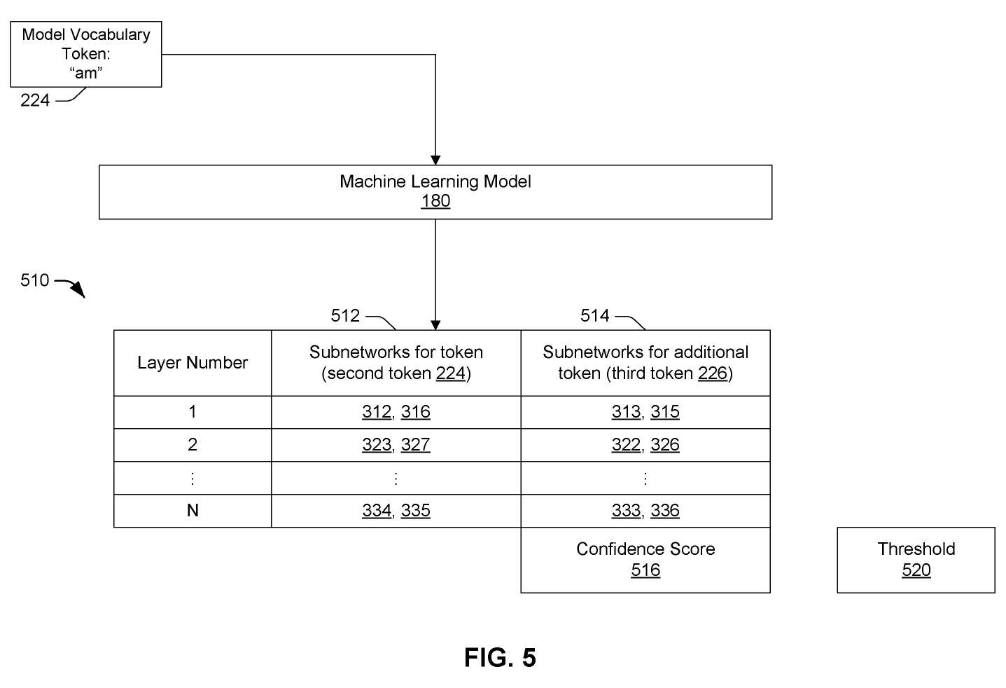

FIG. 5 illustrates a representation of an output 510 generated by a machine learning model 180 based on a token to be processed by a generative large language model 160, according to embodiments of the disclosure. As shown, the token is the second token 224 which is also illustrated in FIG. 3A. In the representation shown in FIG. 5, the generative large language model 160 generates the second token 224 as part of processing the user input 202 depicted in FIGS. 2 and 4.

In some embodiments, the machine learning model 180 identifies the second token 224 to be processed by the generative large language model 160 and the machine learning model 180 generates the output 510 based on the second token 224. In these embodiments, the machine learning model 180 does not necessarily receive the second token 224 in order to generate the output 510. For instance, the machine learning model 180 is capable of generating the output 510 based on receiving an identification of the second token 224.

In the example illustrated in FIG. 5, the machine learning model 180 generates the output 510 as including subnetworks selected for a token 512 (a current iteration of processing the second token 224) by the generative large language model 160, subnetworks selected for an additional token 514 (a next iteration of processing the third token 226) by the generative large language model 160, and a confidence score 516 for the subnetworks selected for the additional token 514 (the next iteration of processing the third token 226). As shown in FIGS. 5 and 3A, the subnetworks selected for the token 512 include the subnetworks 312, 316 from the first layer 172; the subnetworks 323, 327 from the second layer 174; and the subnetworks 334, 335 from the Nth layer 176. As shown in FIGS. 5 and 3B, the subnetworks selected for the additional token 514 include the subnetworks 313, 315 from the first layer 172; the subnetworks 322, 326 from the second layer 174; and the subnetworks 333, 336 from the Nth layer 176.

Although the illustrated example depicts the same number of subnetworks (e.g., two) selected from the first layer 172, the second layer 174, and the Nth layer 176, it is to be appreciated that, in some embodiments, the generative large language model 160 may select different numbers of subnetworks from layers included in the model layers 170. In some embodiments, based on the output 510, the subnetworks 312, 316, 323, 327, 334, 335 may be prefetched (e.g., from a “slow” memory into a “fast” memory) in order to process the second token 224. The subnetworks 313, 315, 322, 326, 333, 336 may or may not be prefetched in order to process the third token 226 based on the confidence score 516. As described above, the confidence score 516 indicates an amount of certainty that the identified subnetworks to be selected for the additional token 514 will be selected by the generative large language model 160 in order to process the third token 226. In some embodiments, the confidence score 516 indicates a likelihood that the third token 226 is processed by the generative large language model 160 following (e.g., next after) the second token 224.

In order to generate the confidence score 516, in some embodiments, the machine learning model 180 may utilize a probability score for the third token 226 (e.g., the likelihood that the third token 226 is processed following the second token 224) computed by the generative large language model 160. In some embodiments, the generative large language model 160 computes probability scores for candidate tokens and then generates or selects a candidate token with a highest probability score to be the next token to process using the model layers 170. As shown in FIG. 4, in some embodiments, the machine learning model 180 may receive (e.g., as an output from the model layers 170) a probability score for the third token 226 computed by the generative large language model 160.

Consider an example in which the machine learning model 180 receives the probability score computed for the third token 226 from the generative large language model 160. In this example, the probability score received by the machine learning model 180 may be processed using a sigmoid function in order to generate the confidence score 516 as a normalized confidence score. For instance, the sigmoid function maps the probability score to a value between 0 and 1 in order to compute the confidence score 516 as the normalized confidence score.

In some embodiments, the confidence score 516 (e.g., the normalized confidence score) is compared to a threshold value 520 (e.g., 0.4, 0.5, 0.6, or another value). The threshold value 520 may be a value between 0 and 1 which may be a fixed value (e.g., 0.5) or a variable value (e.g., different values for different tasks). If the confidence score 516 for the subnetworks selected for the additional token 514 is greater than the threshold value 520, then the subnetworks 313, 315, 322, 326, 333, 336 may be prefetched to process the third token 226. If the confidence score 516 for the subnetworks selected for the additional token 514 is less than the threshold value 520, then the subnetworks 313, 315, 322, 326, 333, 336 may not be prefetched.

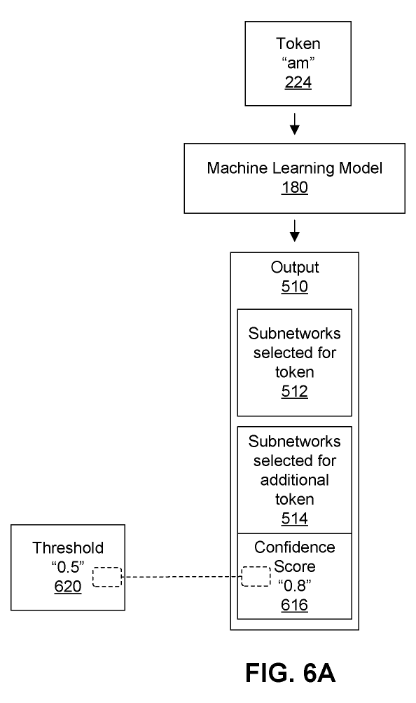

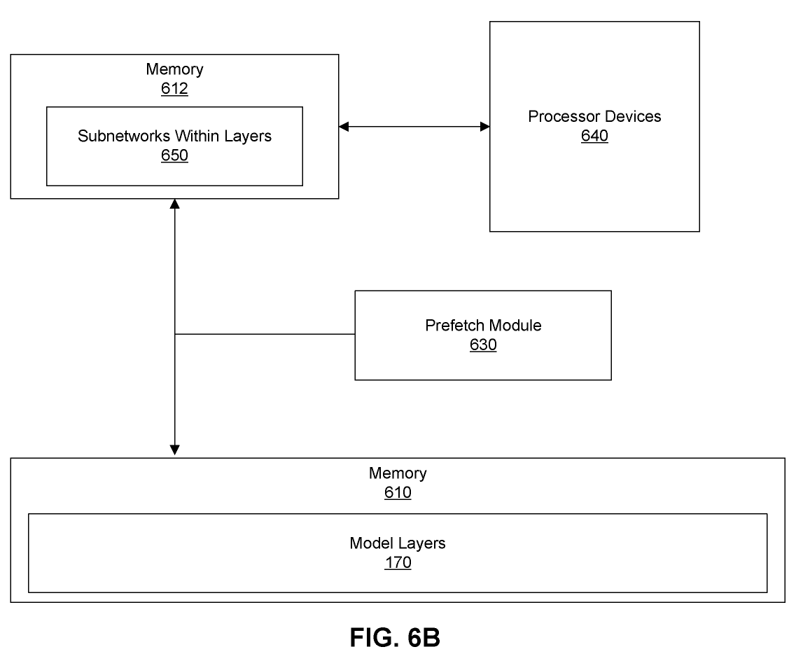

FIG. 6A illustrates a representation a logical portion of prefetching subnetworks of a generative large language model 160, according to embodiments of the disclosure. FIG. 6B illustrates a representation of a physical portion of prefetching subnetworks of a generative large language model 160, according to embodiments of the disclosure. As shown in FIG. 6B, the representation includes a first memory 610 (e.g., of a first memory device 140); a second memory 612 (e.g., of a second memory device 140); a prefetch module 630; and processor devices 640. In some embodiments, the processor devices 640 include one or more compute devices 142. The first memory 610 is illustrated to include data describing the model layers 170 of the generative large language model 160. In some embodiments, for access by the processor devices 640, the first memory 610 may be a “slow” memory (e.g., storage) and the second memory 612 may be a “fast” memory (e.g., a cache).

In some embodiments, the machine learning model 180 identifies/receives the second token 224 as a token to be processed using the model layers 170 of the generative large language model 160. As shown in FIG. 6A, the machine learning model 180 generates the output 510 based on the second token 224. As described above, the output 510 includes the subnetworks selected for the token 512 including, for example, the subnetworks 312, 316 from the first layer 172; the subnetworks 323, 327 from the second layer 174; and the subnetworks 334, 335 from the Nth layer 176. The output 510 also includes the subnetworks selected for the additional token 514 (e.g., the third token 226) including, for example, the subnetworks 313, 315 from the first layer 172; the subnetworks 322, 326 from the second layer 174; and the subnetworks 333, 336 from the Nth layer 176.

The output 510 is illustrated to include a confidence score 616 which is 0.8. As shown in FIG. 6A, the confidence score 616 is compared to a threshold value 620 which is 0.5. In the illustrated example, because the confidence score 616 of 0.8 is greater than the threshold value 620 of 0.5, the subnetworks 312, 316, 323, 327, 334, 335 may be prefetched (e.g., from the first memory 610) in order to process the second token 224 and the subnetworks 313, 315, 322, 326, 333, 336 may be prefetched (e.g., from the first memory 610) in order to process the third token 226. It is to be appreciated that, in some embodiments, if the confidence score 616 is less than the threshold value 620, then the subnetworks 313, 315, 322, 326, 333, 336 may not be prefetched.

With reference to FIG. 6B, the prefetch module 630 (e.g., any hardware/software capable of prefetching data) prefetches data describing subnetworks within layers 650 as including, for example, the subnetworks 312, 316, 323, 327, 334, 335 (for the second token 224) and the subnetworks 313, 315, 322, 326, 333, 336 (for the third token 226) from the first memory 610. As shown in FIG. 6B, the prefetch module 630 writes the data describing subnetworks within layers 650 to the second memory 612. It is to be appreciated that, in some embodiments, writing the data describing subnetworks within layers 650 to the second memory 612 (e.g., before the data is requested by the processor devices 640) may avoid latency incurred in reading the data describing subnetworks within layers 650 from the first memory 610 while the processing of such layers is being performed.

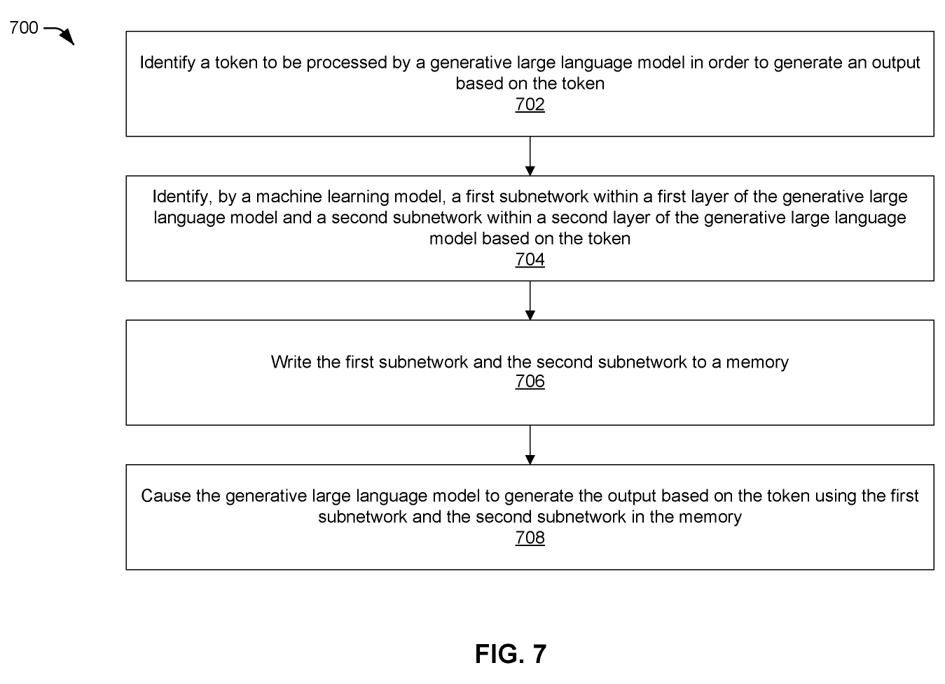

FIG. 7 shows a flowchart of an example procedure 700 for writing a first subnetwork and a second subnetwork to a memory, according to embodiments of the disclosure. At block 702, a token to be processed by a generative large language model 160 in order to generate an output based on the token is identified. At block 704, a machine learning model 180 identifies a first subnetwork within a first layer of the generative large language model 160 and a second subnetwork within a second layer of the generative large language model 160 based on the token. At block 706, the first subnetwork and the second subnetwork are written to a memory. At block 708, the generative large language model 160 is caused to generate the output based on the token using the first subnetwork and the second subnetwork in the memory.

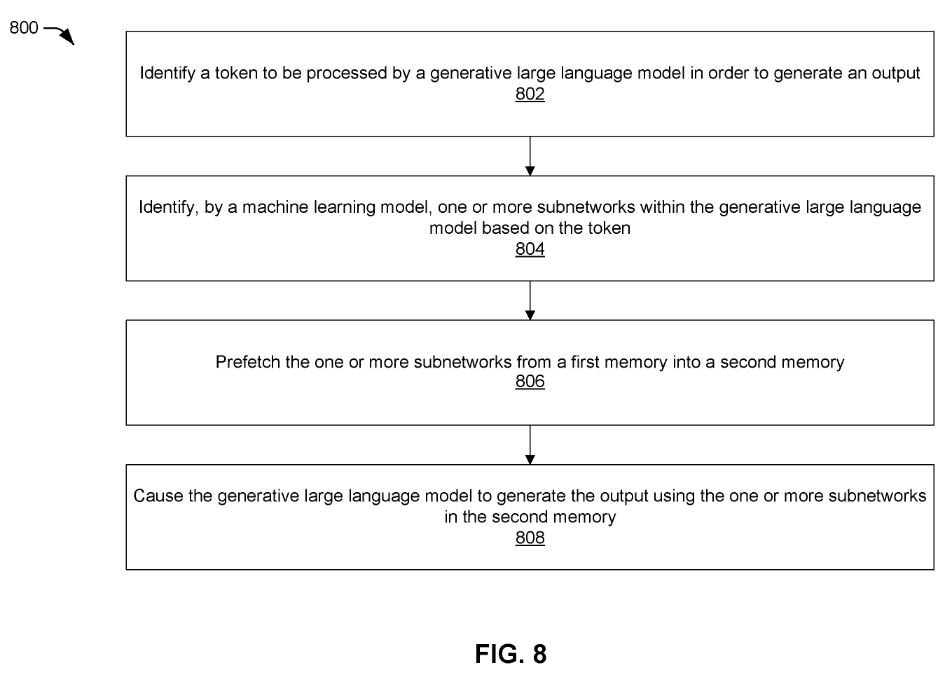

FIG. 8 shows a flowchart of an example procedure 800 for causing a generative large language model 160 to generate an output using subnetworks in a second memory, according to embodiments of the disclosure. At block 802, a token to be processed by a generative large language model 160 in order to generate an output is identified. At block 804, a machine learning model 180 identifies one or more subnetworks within the generative large language model 160 based on the token. At block 806, the one or more subnetworks are prefetched from a first memory into a second memory. At block 808, the generative large language model 160 is caused to generate the output using the one or more subnetworks in the second memory.

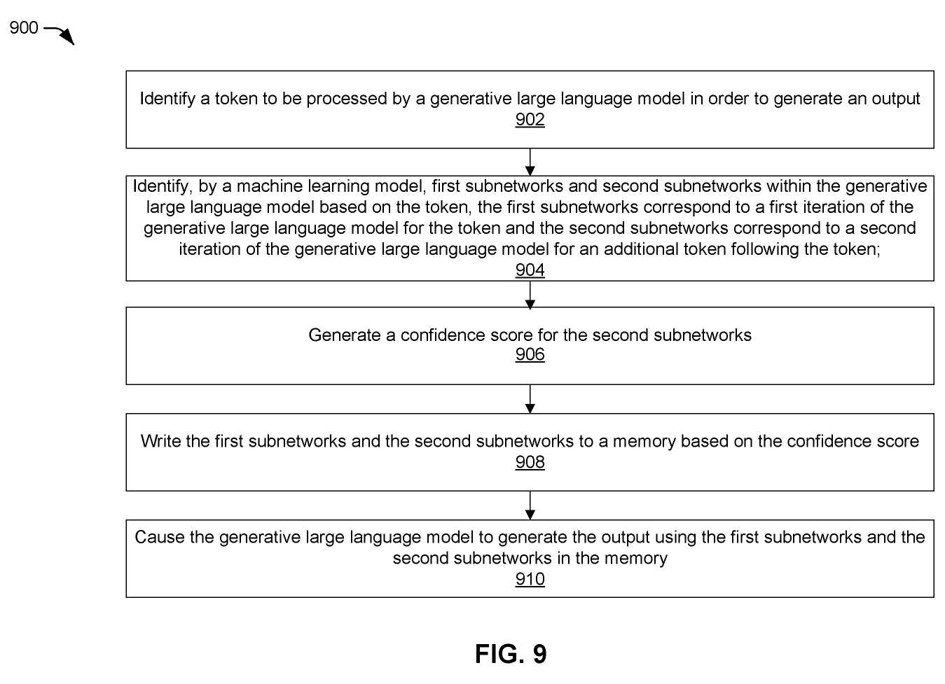

FIG. 9 shows a flowchart of an example procedure 900 for causing a generative large language model 160 to generate an output using first subnetworks and second subnetworks in a memory, according to embodiments of the disclosure. At block 902, a token to be processed by a generative large language model 160 in order to generate an output is identified. At block 904, a machine learning model 180 identifies first subnetworks and second subnetworks within the generative large language model 160 based on the token, the first subnetworks correspond to a first iteration of the generative large language model 160 for the token and the second subnetworks correspond to a second iteration of the generative large language model 160 for an additional token following the token. At block 906, a confidence score is generated for the second subnetworks. At block 908, the first subnetworks and the second subnetworks are written to a memory based on the confidence score. At block 910, the generative large language model 160 is caused to generate the output using the first subnetworks and the second subnetworks in the memory.

In FIGS. 7-9, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, application specific integrated circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., random access memory (RAM), read only memory (ROM), etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium (e.g., a computer-readable storage medium) comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in random access memory (RAM), flash memory, read only memory (ROM), electrically programmable ROM (EPROM), electrically erasable programmable ROM (EEPROM), registers, hard disk, a removable disk, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A method comprising:
identifying a token to be processed by a generative large language model in order to generate an output based on the token;
identifying, by a machine learning model, a first subnetwork within a first layer of the generative large language model and a second subnetwork within a second layer of the generative large language model based on the token;
writing the first subnetwork and the second subnetwork to a memory; and
causing the generative large language model to generate the output based on the token using the first subnetwork and the second subnetwork in the memory.

2. The method according to claim 1, further comprising:
identifying, by the machine learning model, a third subnetwork within the first layer of the generative large language model; and
writing the third subnetwork to the memory.

3. The method according to claim 2, wherein the first subnetwork and the third subnetwork within the first layer and the second subnetwork within the second layer correspond to an iteration of the generative large language model for the token.

4. The method according to claim 2, wherein the third subnetwork within the first layer corresponds to an iteration of the generative large language model for an additional token following the token.

5. The method according to claim 4, further comprising:
identifying, by the machine learning model, a fourth subnetwork within the second layer of the generative large language model; and
writing the fourth subnetwork to the memory, wherein the fourth subnetwork within the second layer corresponds to the iteration of the generative large language model for the additional token following the token.

6. The method according to claim 1, wherein the first subnetwork within the first layer corresponds to a first iteration of the generative large language model for the token.

7. The method according to claim 6, wherein the first subnetwork within the first layer corresponds to a second iteration of the generative large language model for an additional token following the token.

8. The method according to claim 1, further comprising:
identifying, by the machine learning model, a third subnetwork within the first layer of the generative large language model; and
generating, by the machine learning model, a normalized confidence score for the third subnetwork within the first layer.

9. The method according to claim 8, wherein the normalized confidence score indicates a likelihood of the third subnetwork within the first layer being selected in an iteration of the generative large language model for an additional token following the token.

10. The method according to claim 8, further comprising writing the third subnetwork to the memory based on the normalized confidence score.

11. A method comprising:
identifying a token to be processed by a generative large language model in order to generate an output;
identifying, by a machine learning model, one or more subnetworks within the generative large language model based on the token;
prefetching the one or more subnetworks from a first memory into a second memory; and
causing the generative large language model to generate the output using the one or more subnetworks in the second memory.

12. The method according to claim 11, wherein the one or more subnetworks comprise first subnetworks corresponding to a first iteration of the generative large language model for the token and second subnetworks corresponding to a second iteration of the generative large language model for an additional token following the token.

13. The method according to claim 12, wherein a particular subnetwork of the one or more subnetworks is included in the first subnetworks and the second subnetworks.

14. The method according to claim 11, wherein the one or more subnetworks comprise a first number of subnetworks within a first layer of the generative large language model and a second number of subnetworks within a second layer of the generative large language model.

15. The method according to claim 11, wherein the machine learning model comprises at least one multilayer perceptron.

16. The method according to claim 15, wherein the machine learning model is trained to predict subnetworks as part of training the generative large language model to generate outputs.

17. A method comprising:
identifying a token to be processed by a generative large language model in order to generate an output;
identifying, by a machine learning model, first subnetworks and second subnetworks within the generative large language model based on the token, the first subnetworks correspond to a first iteration of the generative large language model for the token and the second subnetworks correspond to a second iteration of the generative large language model for an additional token following the token;
writing the first subnetworks to a memory; and
causing the generative large language model to generate the output using the first subnetworks in the memory.

18. The method according to claim 17, further comprising:
generating, by the machine learning model, a confidence score for the second subnetworks; and
writing the second subnetworks to the memory based on the confidence score.

19. The method according to claim 17, wherein the machine learning model comprises a multilayer perceptron.

20. The method according to claim 17, wherein a particular subnetwork is included in the first subnetworks and the second subnetworks.
